(19) United States
(12) Patent Application Publication
(10) Pub. No.: US 2023/0107813 A1
(43) Pub. Date: Apr. 6, 2023

(54) TIME CONSTRAINT MANAGEMENT AT A MANUFACTURING SYSTEM

(71) Applicant: APPLIED MATERIALS, INC., Santa Clara, CA (US)

(72) Inventor: David E. Norman, Bountiful, UT (US)

(21) Appl. No.: 17/495,140

(22) Filed: Oct. 6, 2021

(51) Int. Cl. G05B 19/418; G06N 20/00; G05B 13/02

(52) U.S. Cl. CPC G05B 19/41865; G06N 20/00; G05B 13/0265; G05B 2219/31372

(57) ABSTRACT

A method for time constraint management at a manufacturing system is provided. The method includes receiving a request to initiate a set of operations to be run at a manufacturing system, wherein the set of operations comprises one or more operations that each have one or more time constraints. The method further includes obtaining current data relating to a current state of the manufacturing system. The method further includes applying a machine-learning model to the current data to determine a candidate set of substrates to be processed during the set of operations. The method further includes initiating the set of operations on the candidate set of substrates based on an output of the machine-learning model.

### TECHNICAL FIELD

The present disclosure relates to electrical components, and, more particularly, to methods and mechanisms for time constraint management at a manufacturing system.

### BACKGROUND

Before a substrate becomes a finished product (e.g., a wafer, an electronic device, etc.), the substrate can be processed according to a set of operations each performed at a tool of a manufacturing system. In some instances, one or more operations can be subject to a time constraint. A time constraint refers to a particular amount of time after an operation is completed that a subsequent operation is to be completed. For example, a substrate can be processed according to a first operation where a first material is deposited on a surface of the substrate and a second operation where a second material is deposited on the first material. The first operation and the second operation can be subject to a time constraint where the second material is to be deposited on the first material within a particular amount of time, otherwise the first material can begin to degrade and the substrate cannot be used to produce a finished product (i.e., becomes unusable). A time constraint window refers to a particular amount of time to complete an operation that prompts a time constraint (referred to as an initiating operation) and the amount of time after the initiating operation is completed that a subsequent operation (referred to a completion operation) is to be completed. In some instances, one or more operations can be performed between the initiating operation and the completion operation.

In most instances, an operation cannot be started for a substrate when the substrate arrives at the tool, as the tool can be processing other substrates. As such, an operator of the manufacturing system (e.g., an industrial engineer, a process engineer a system engineer, etc.) schedules operations to run at particular times in order to satisfy a time constraint associated with the operation. For example, an operator can delay an operation from being performed for a substrate until each tool set to perform an operation associated with a time constraint has capacity to perform the operation within the time constraint window.

In some instances, a completion operation for a first time constraint window can also be an initiating operation for a second time constraint window. In such instances, an operator of a manufacturing system can schedule an initiating operation for the first time constraint window to start at a particular time to satisfy a first time constraint of the first time constraint window and a second time constraint of the second time constraint window. In other instances, an operation can be a completion operation for both a first time constraint window and a second time constraint window. In such instances, an operator can schedule initiating operations for the first time constraint window and the second time constraint window to start at a particular time to satisfy a first time constraint of the first time constraint window and a second time constraint of the second time constraint window.

As manufacturing systems become more complex, more operations are subject to time constraints. In order to schedule a substrate to be started at an initiating operation, an operator (e.g., using a computing system) accounts for all time constraints that could be prompted by the initiating operation. To account for all time constraints that could be prompted by the initiating operation, the operator accounts for a capacity of each tool that can perform the initiating operation, the completion operation, and each operation in between. In some instances, a time constraint window including the initiating operation can correspond to a significant amount of time (e.g., 6 hours, 8 hours, 12 hours, 24 hours, etc.). The operator can have difficulty in accounting for each time constraint and capacities for each tool of the manufacturing system for a significant amount of time into the future. For some computing systems, this accounting can be classified as a NP-hard (non-deterministic polynomial-time hard) problem. As such, the operator can be unsuccessful in scheduling a substrate to be started at each initiating operation of the set of operations so that each time constraint can be satisfied. As a result, the substrate can violate a time constraint of the set of operations and become unusable. Each substrate that becomes unusable can reduce overall system throughput and contribute to increasing overall system latency.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method for time constraint management at a manufacturing system is provided. The method includes receiving a request to initiate a set of operations to be run at a manufacturing system, wherein the set of operations comprises one or more operations that each have one or more time constraints. The method further includes obtaining current data relating to a current state of the manufacturing system. The method further includes applying a machine-learning model to the current data to determine a candidate set of substrates to be processed during the set of operations. The method further includes initiating the set of operations on the candidate set of substrates based on an output of the machine-learning model.

In another aspect of the disclosure a system comprising a memory and a processing device operatively coupled to the memory is provided. The processing device performs instructions comprising receiving a request to initiate a set of operations to be run at a manufacturing system, wherein the set of operations comprises one or more operations that each have one or more time constraints. The processing device performs further instructions including obtaining current data relating to a current state of the manufacturing system. The processing device performs further instructions including applying a machine-learning model to the current data to determine a candidate set of substrates to be processed during the set of operations. The processing device performs further instructions including initiating the set of operations on the candidate set of substrates based on an output of the machine-learning model.

In another aspect of the disclosure, a method for training a machine-learning model is provided. The method includes obtaining state data associated with operations related to the fabrication of substrates. The method further includes determining a training set of substrates to be processed during a training set of operations. The method further includes running a simulation, associated with the state data, of the training set of operations for the training set of substrates over a time period. The method further includes training a machine-learning model based on an output of the simulation.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIG. 2 is a flow diagram of a method for training a machine-learning model, according to certain embodiments.

FIG. 3 is a top schematic view of an example manufacturing system, according to certain embodiments.

FIG. 4 illustrates a set of operations subject to one or more time constraints, in accordance with embodiments of the present disclosure.

FIG. 5 is a flow diagram showing a method of initiating a set of operations based on the dispatching decisions generated using a machine-learning model, according to certain embodiments.

FIG. 6 is another flow diagram showing a method of initiating a set of operations based on the dispatching decisions generated using a machine-learning model, according to certain embodiments.

FIG. 7 is a block diagram illustrating a computer system, according to certain embodiments.

### DETAILED DESCRIPTION

Described herein are technologies directed to time constraint management at a manufacturing system. In some processes, a series of operations can be performed at various stages of the manufacturing system. For example, a series of operations can be performed to deposit a coating (or multiple coatings) on a surface of a substrate and etch a three-dimensional pattern into the coating. In some instances, one or more of the series of operations can be subject to a time constraint. A time constraint can refer to a limitation or protocol in which, after an operation is performed at the manufacturing system, a subsequent operation is to be completed within a particular amount of time. For example, the manufacturing system can be subject to a time constraint where the etch process is to be performed for the substrate within a particular number of hours (e.g., 12 hours) after the coating is deposited on the surface of a substrate. If the time constraint is not satisfied (e.g., if the etch process is not performed within the particular number of hours), the substrate can become defective and unusable.

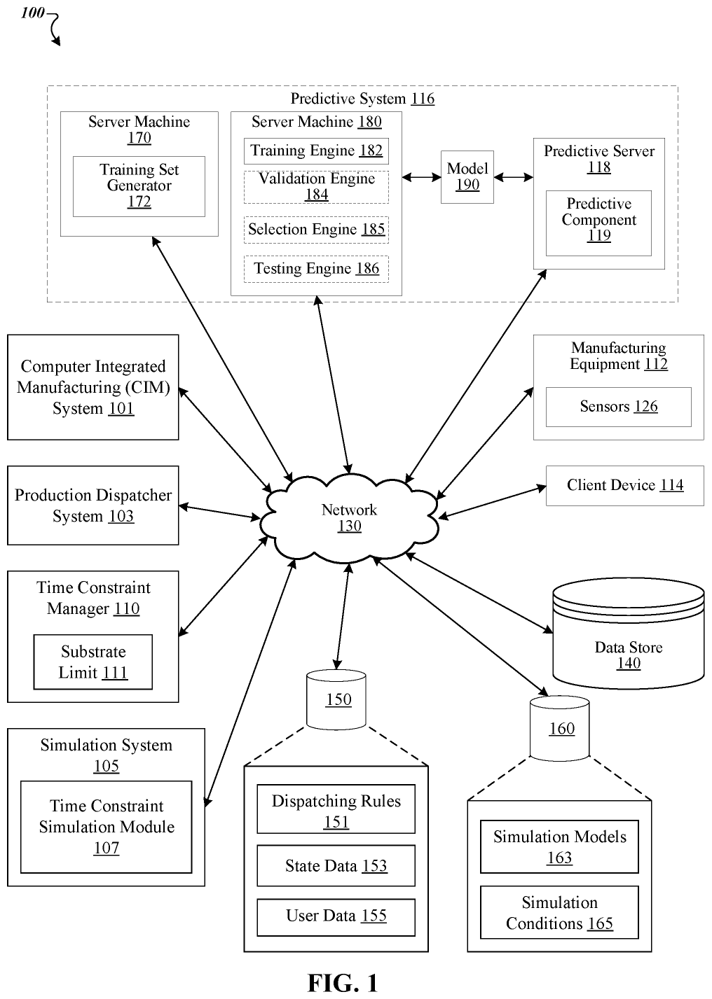

Embodiments of the present disclosure are directed to managing time constraints at a manufacturing system. A processing device, such as a processing device executing a time constraint window manager (e.g., time constraint window manager 110 of FIG. 1), can receive a request to initiate operations to be run at a manufacturing system, where one or more operations are subject to a time constraint. The processing device can determine, in view of the time constraints, a number of substrates that can be successfully processed at the manufacturing system within a particular time period. For example, the processing device can identify a set of candidate substrates at the manufacturing system to be processed during the set of operations. In some embodiments, the processing device can determine the set of candidate substrates based on a queue of substrates to be processed at the manufacturing system.

To identify a set of candidate substrates, the processing device can obtain data relating to the current state of manufacturing equipment. The data can include current state data, sensor data, contextual data, task data, etc. For example, the current data can relate to one or more operations being performed on one or more substrates being processed, a number of substrates being processed at the manufacturing equipment at a particular instance of time, a number of substrates in a manufacturing equipment queue, current service life, setup data, a set of operations that include individual processes performed at one or more manufacturing facilities of a production environment, sensor data, etc. The processing device can then apply a machine-learning model (e.g., a model trained using reinforcement learning) to the data relating to the current state of manufacturing equipment. The machine-learning model can be trained using state data associated with operations related to the fabrication of semiconductor substrates. In some embodiments, the state data is associated with operations related to the fabrication of semiconductor substrates that includes current state data, historical state data, or perturbed state data. Current state data can include data relating to the current state of the manufacturing equipment. Historical state data can include data relating to a past state of the manufacturing equipment. Perturbed state data can include modified state data (e.g., current or historical state data that has had one or more parameters modified or distorted).

The machine-learning model can be used to generate predictive data. In some embodiments, the predictive data can include one or more dispatching decisions. A dispatching decision can decide what action should be performed at a given time in the production environment. In some embodiments, the dispatching decision can indicate at which time to process a set of candidate substrates. In other embodiments, dispatching can involve decisions such as whether to start processing a batch that has fewer substrates than allowed, or wait to start the batch until additional substrates are available so a full batch can be started. Examples of dispatching decisions can include, and are not limited to, where a substrate should be processed next in the production environment, which substrate should be picked for an idle piece of equipment in the production environment, and so forth. Based on the predictive data, the processing device can initiate the set of operations on the candidate set of substrates at a particular time.

In some embodiments, the processing device can run a simulation on the predictive data. The simulation can be performed on the dispatching decision(s) and based on dispatching rules for the manufacturing system (e.g., rules used to determine which action should be performed at the manufacturing system at a given time), state data associated with the manufacturing system, and/or user data provided by a user of the manufacturing system (e.g., an operation, an industrial engineer, a process engineer, a system engineer, etc.). The simulation can generate an output indicating the number of candidate substrates that were successfully processed during each of the simulated set of operations to reach an end of the simulation time period. The simulation can be used to verify that the predictive data does not result in time constraint errors. The processing device can initiate the set of operations at the manufacturing system to process the number of candidate substrates over the time period based on the predictive data and/or the simulation output.

Aspects and implementations of the present disclosure address the shortcomings of the existing technology by providing techniques for predicting a number of substrates that will be successfully processed according to a set of operations having one or more time constraints. A processing device can apply a trained machine-learning model to the set of operations to determine a set of candidate substrates for processing during a current or future time period. By applying the trained machine-learning model, the processing device can obtain a dispatching decision indicative of number of substrates that are likely to be successfully processed according to the set of operations over the time period. By obtaining the number of substrates that are likely to be successfully processed over the time period, the processing device can schedule an appropriate number of substrates to be initiated at the set of operations within the time period so that few or no substrates violate a time constraint for the set of operations. As a result, a small number of substrates, or approximately zero substrates, will violate a time constraint of the set of operations, resulting in a significant number of substrates processed at the manufacturing system containing no or few defects. As a result, an overall system throughput increases and an overall system latency decreases, as a higher number of substrates processed at the manufacturing system become useable final products.

FIG. 1 is a block diagram illustrating a production environment 100, according to aspects of the present disclosure. A production environment 100 can include multiple systems, such as, and not limited to, a production dispatcher system 103, a simulation system 105, a time constraint window manager 110, manufacturing equipment 112 (e.g., manufacturing tools, automated devices, etc.), a client device 114, a predictive system 116 (e.g., to generate predictive data, to provide model adaptation, to use a knowledge base, etc.) and one or more computer integrated manufacturing (CIM) systems 101. Examples of a production environment 100 can include, and are not limited to, a manufacturing plant, a fulfillment center, etc. For brevity and simplicity, a manufacturing system is used as an example of a production environment 100 throughout this description.

In some embodiments, production environment 100 can be a semiconductor manufacturing environment. In such embodiments, manufacturing equipment 112 can perform multiple different operations related to the fabrication of semiconductor substrates. For example, manufacturing equipment 112 can perform cutting operations, cleaning operations, deposition operations, etching operations, testing operations, and so forth. Aspects of the present disclosure are described with regard to fabrication of semiconductor substrates in a semiconductor manufacturing environment. However, it should be noted that implementations of the present disclosure can be applied to other production environments 100 configured to fabricate or otherwise process lots different from semiconductor substrates.

The manufacturing equipment 112 can include sensors 126 configured to capture data for a substrate being processed at the manufacturing equipment 112. In some embodiments, the manufacturing equipment 112 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some embodiments, manufacturing equipment 112 can include, or be operationally coupled to, metrology equipment that includes a metrology server (e.g., a metrology database, metrology folders, etc.) and metrology identifier reader (e.g., FOUP RFID reader for metrology system).

Manufacturing equipment 112 can produce products, such as electronic devices, following a recipe or performing runs over a period of time. Manufacturing equipment 112 can include a process chamber. Manufacturing equipment 112 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 122 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

In some embodiments, sensors 126 provide sensor data (e.g., sensor values, features, trace data) associated with manufacturing equipment 112 (e.g., associated with producing, by manufacturing equipment 112, corresponding products, such as wafers). The manufacturing equipment 112 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 112. The sensor data can be provided while the manufacturing equipment 112 is performing manufacturing processes (e.g., equipment readings when processing products). The sensor data can be different for each substrate.

The CIM 101, production dispatcher system 103, simulation system 105, time constraint simulation module 107, time constraint window manager 110, manufacturing equipment 112, client device 114, predictive system 116, and data stores 140, 150, 160 can be coupled to each other via network 120. Network 120 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof. The CIM system 101, production dispatcher system 103, simulation system 105, time constraint simulation module 107, time constraint window manager 110, and predictive system 116 can be individually hosted or hosted in any combination together by any type of machine including server computers, gateway computers, desktop computers, laptop computers, tablet computers, notebook computers, PDAs (personal digital assistants), mobile communication devices, cell phones, smart phones, hand-held computers, or similar computing devices. In some embodiments, simulation module 107 is part of a server that is hosted on a machine. In some embodiments, predictive system 116 is part of a server that is hosted on a machine.

Data stores 140, 150, and 160 can be a memory (e.g., random access memory), a drive (e.g., a hard drive, a flash drive), a database system, or another type of component or device capable of storing data. Data stores 140, 150, and 160 can include multiple storage components (e.g., multiple drives or multiple databases) that can span multiple computing devices (e.g., multiple server computers).

Data store 140 can store data associated with processing a substrate at manufacturing equipment 112. For example, data store 140 can store data collected by sensors 126 at manufacturing equipment 112 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at manufacturing equipment 112. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some embodiments, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some embodiments, all data stored at data store 140 can be inaccessible by the user of the manufacturing system. In other or similar embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In other or similar embodiments, data store 140 can include multiple data stores where data that is inaccessible to the user is stored in one or more first data stores and data that is accessible to the user is stored in one or more second data stores.

Data store 150 dispatching rules 151, state data 153, and user data 155. Dispatching rules 151 can be logic that can be executed by the production dispatcher system 103. In some embodiments, dispatching rules 151 can be user (e.g., industrial engineer, process engineer, system engineer, etc.) defined. Examples of dispatching rules 151 can include, and are not limited to, select the highest priority substrate to work on next, select a substrate that uses the same set up which the tool is currently configured for, package items when a purchase order is complete, ship items when packaging is complete, etc. The individual dispatching rules 151 can be associated with a large number of data processes to implement the corresponding dispatching rule 151. Examples of data processes can include, and are not limited to import data, compress data, index data, filter data, perform a mathematical function on data, etc.

State data 153 can include a state of manufacturing equipment 112 (e.g., an operating temperature, an operating pressure, a number of substrates being processed at the manufacturing equipment, a number of substrates in a manufacturing equipment queue at a particular instance of time, current service life, setup data, a set of operations that include individual processes performed at one or more manufacturing facilities of a production environment, etc. State data 153 can be generated by manufacturing equipment 112 during operation of production environment 100 and stored at data store 150. State data 153 can include one or more of current state data, historical state data, and perturbed state data. Current state data can include data relating to the current state of manufacturing equipment 112 (e.g., current operating temperature, current operating pressure, current number of substrates being processed at the manufacturing equipment, etc.). Historical state data can include data relating to a past state of manufacturing equipment 112 (e.g., past operating temperature at a particular instance of time, past operating pressure at a particular instance of time, past number of substrates being processed at the manufacturing equipment at a particular instance of time, etc.). Perturbed state data can include modified state data. In particular, perturbed state data can include current or historical state data that has had one or more parameters modified or distorted. The one or more parameters can be modified based on user input, a certain percentage, a certain value, randomly modified, etc. For example, perturbed state data can include a past number of substrates being processed at the manufacturing equipment at a particular instance of time reduced or increased by a predetermined value of two substrates. In another example, perturbed state data can include a past number of substrates sets being processed at the manufacturing equipment at a particular instance of time reduced or increased by a random number of sets between, for example, one and ten. In some embodiments, state data 153 can include, or be generated from, the data stored in data store 140. For example, state data 153 can include, or be generated from, sensor data, contextual data, task data, etc.

User data 155 can include data provided by a user of production environment 100 (e.g., an operator, a process engineer, industrial engineer, system engineer, etc.). In some embodiments, user data 155 can be provided via client device 114.

A user device 114 can include a computing device such as a personal computer (PC), laptop, mobile phone, smart phone, tablet computer, netbook computer, network-connected television, etc. In some embodiments, user device 114 can provide information to a user (e.g., an operator, an industrial engineer, a process engineer, a system engineer, etc.) of production environment 100 via one or more graphical user interfaces (GUIs).

Examples of CIM systems 101 can include, and are not limited to, a manufacturing execution system (MES), enterprise resource planning (ERP), production planning and control (PPC), computer-aided systems (e.g., design, engineering, manufacturing, processing planning, quality assurance), computer numerical controlled machine tools, direct numerical control machine tools, controllers, etc.

In some embodiments, predictive system 114 includes predictive server 112, server machine 170 and server machine 180. The predictive server 118, server machine 170, and server machine 180 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

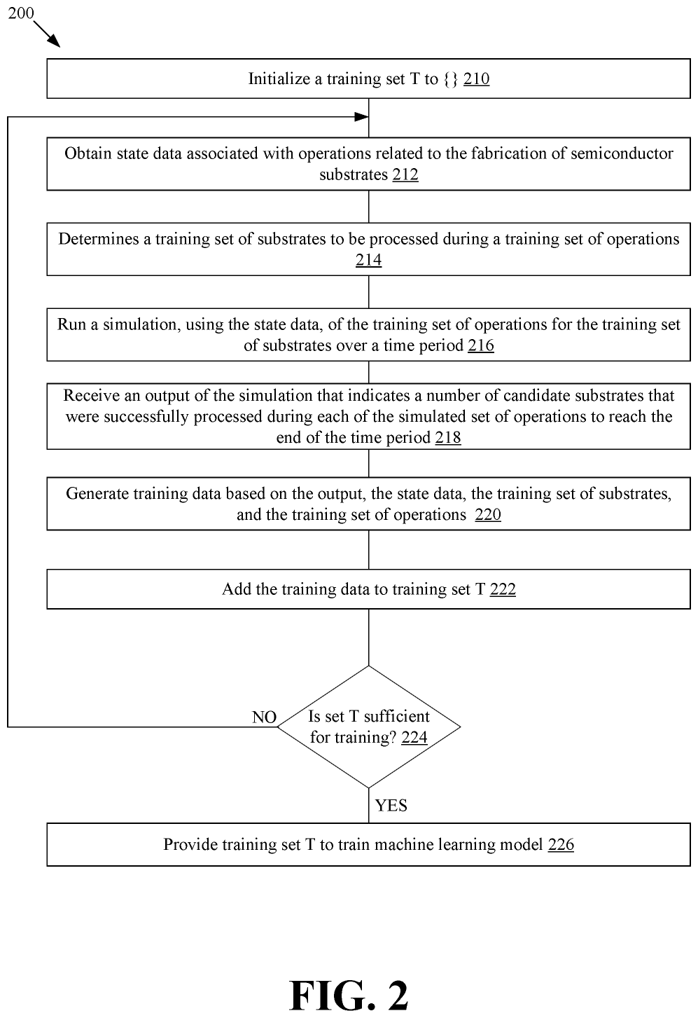

Server machine 170 includes a training set generator 172 that is capable of generating training data sets (e.g., a set of data inputs and a set of target outputs) to train, validate, and/or test a machine-learning model 190. Machine-learning model 190 can be any algorithmic model capable of learning from data. Some operations of data set generator 172 is described in detail below with respect to FIG. 2. In some embodiments, the data set generator 172 can partition the training data into a training set, a validating set, and a testing set. In some embodiments, the predictive system 116 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training one or more machine-learning models 190. Machine-learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine-learning model 190 that captures these patterns. The machine-learning model 190 can use one or more of a statistical modelling, support vector machine (SVM), Radial Basis Function (RBF), clustering, reinforcement learning, supervised machine-learning, semi-supervised machine-learning, unsupervised machine-learning, k-nearest neighbor algorithm (k-NN), linear regression, random forest, neural network (e.g., artificial neural network), etc.

One type of machine-learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g. classification outputs). Deep learning is a class of machine-learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In a plasma process tuning, for example, the raw input can be process result profiles (e.g., thickness profiles indicative of one or more thickness values across a surface of a substrate); the second layer can compose feature data associated with a status of one or more zones of controlled elements of a plasma process system (e.g., orientation of zones, plasma exposure duration, etc.); the third layer can include a starting recipe (e.g., a recipe used as a starting point for determining an updated process recipe the process a substrate to generate a process result the meets threshold criteria). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In one embodiment, one or more machine-learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In some embodiments, training of a neural network can be achieved using reinforcement learning. Reinforcement learning differs from supervised learning in not needing labelled input/output pairs be presented, and in not needing sub-optimal actions to be explicitly corrected. The focus of reinforcement learning can be on finding a balance between exploration of uncharted territory and exploitation of current knowledge. Partially supervised reinforcement algorithms can combine the advantages of supervised and RL algorithms.

A training dataset containing hundreds, thousands, tens of thousands, hundreds of thousands or more sensor data, process result data (e.g., metrology data such as one or more thickness profiles associated with the sensor data), and/or state data 153 can be used to form a training dataset.

To effectuate training, processing logic can input the training dataset(s) into one or more untrained machine-learning models. Prior to inputting a first input into a machine-learning model, the machine-learning model can be initialized. Processing logic trains the untrained machine-learning model(s) based on the training dataset(s) to generate one or more trained machine-learning models that perform various operations as set forth above. Training can be performed by inputting one or more of the sensor data into the machine-learning model one at a time.

The machine-learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine-learning model can produce.

Accordingly, the output can include one or more predictions or inferences. For example, an output prediction or inference can include whether or not a certain candidate set of substrates can start a time-sensitive constraint within a predetermined amount of time (e.g., the next 15 minutes). Processing logic determines an error (i.e., a classification error) based on the differences between the output (e.g., predictions or inferences) of the machine-learning model and target labels associated with the input training data. Processing logic adjusts weights of one or more nodes in the machine-learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy can be, for example, 70%, 80% or 90% accuracy. In one embodiment, the stopping criterion is met if accuracy of the machine-learning model has stopped improving. If the stopping criterion has not been met, further training is performed. If the stopping criterion has been met, training can be complete. Once the machine-learning model is trained, a reserved portion of the training dataset can be used to test the model.

Once one or more trained machine-learning models 190 are generated, they can be stored in predictive server 118 as predictive component 119 or as a component of predictive component 119.

The validation engine 184 can be capable of validating machine-learning model 190 using a corresponding set of features of a validation set from training set generator 172. Once the model parameters have been optimized, model validation can be performed to determine whether the model has improved and to determine a current accuracy of the deep learning model. The validation engine 184 can determine an accuracy of machine-learning model 190 based on the corresponding sets of features of the validation set. The validation engine 184 can discard a trained machine-learning model 190 that has an accuracy that does not meet a threshold accuracy. In some embodiments, the selection engine 185 can be capable of selecting a trained machine-learning model 190 that has an accuracy that meets a threshold accuracy. In some embodiments, the selection engine 185 can be capable of selecting the trained machine-learning model 190 that has the highest accuracy of the trained machine-learning models 190.

The testing engine 186 can be capable of testing a trained machine-learning model 190 using a corresponding set of features of a testing set from data set generator 172. For example, a first trained machine-learning model 190 that was trained using a first set of features of the training set can be tested using the first set of features of the testing set. The testing engine 186 can determine a trained machine-learning model 190 that has the highest accuracy of all of the trained machine-learning models based on the testing sets.

As described in detail below, predictive server 118 includes a predictive component 119 that is capable of running trained machine-learning model 190 on current state data and providing predicative data indicative of the number of substrates at manufacturing system that can be successfully processed according to a set of operations having one or more time constraints. This will be explained in further detail below.

It should be noted that in some other implementations, the functions of server machines 170 and 180, as well as predictive server 112, can be provided by a fewer number of machines. For example, in some embodiments, server machines 170 and 180 can be integrated into a single machine, while in some other or similar embodiments, server machines 170 and 180, as well as predictive server 112, can be integrated into a single machine.

In general, functions described in one implementation as being performed by server machine 170, server machine 180, and/or predictive server 118 can also be performed on client device 114. In addition, the functionality attributed to a particular component can be performed by different or multiple components operating together

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

The production dispatcher system 103 can make dispatching decisions for the production environment 100. A dispatching decision decides what action should be performed at a given time in the production environment 100. Dispatching often involves decisions such as whether the start processing a batch that has fewer substrates than allowed, or wait to start the batch until additional substrates are available so a full batch can be started. Examples of dispatching decisions can include, and are not limited to, where a substrate should be processed next in the production environment, which substrate should be picked for an idle piece of equipment in the production environment, and so forth. In some embodiments, the production dispatcher system 103 can use the predictive data generated by the predictive component 119 to make a dispatching decision. In some embodiments, the production dispatcher system 103 can use one or more dispatching rules 151 that are stored in the data store 150 to make a dispatching decision.

In some instances, manufacturing processes can include of hundreds of operations performed by manufacturing equipment 112 (e.g., tools or automated devices) within the production environment 100. In many instances, one or more operations can be subjected to a time constraint. As discussed previously, a time constraint refers to a particular amount of time after an operation is completed that a subsequent operation is to be completed. For example, after a first material is deposited on a surface of a substrate, a second material is to be deposited on the first material within a particular amount of time after the deposition of the first material. If the second coating is not deposited on the first material within the particular amount of time, the first material can begin to degrade, leaving the substrate unusable. A time constraint window refers to an amount of time to complete a first operation (referred to as an initiating operation) and the particular amount of time a second operation (referred to as a completion operation) is to be completed. In some embodiments, one or more operations performed between the initiating operation and the completion operation are also associated with the time constraint window. In accordance with the previous example, a time constraint window can refer to a first amount of time to deposit the first material on the surface of the substrate and the particular amount of time in which the second material is to be deposited on the first material. Multiple operations can be subject to one or more time constraints. In some embodiments, a completion operation for a first time constraint window can also be an initiating operation for a second time constraint window.

Time constraint window manager 110 can determine a number of substrates to start at an initiating operation of a time constraint window for a particular time period. In some embodiments, time constraint window manager 110 can determine the number of substrates to be started at the initiating operation in response to a request (e.g., from production dispatcher system 103, from an operator, etc.). The determined number of substrates is referred to as a substrate limit 111. Production dispatcher system 103 can monitor whether a number of substrates started at the initiating operation satisfies the substrate limit 111 by maintaining a substrate counter value. Production dispatcher system 103 can update the substrate counter value (e.g., decrease the substrate counter value by one) for each substrate started at the initiating operation. In some embodiments, production dispatcher system 103 can prevent a substrate from starting at the initiating operation in response to determining the substrate counter value is zero. Time constraint window manager 110 can provide the substrate counter value to production dispatcher system 103 (e.g., as a result of running a simulation at simulation system 105).

A simulation system 105 can run a simulation that is generally faster than the real-time operation of the production environment 100. For example, the simulation system 105 can run a simulation for a week of simulated time in a couple of seconds to test how well the production environment 100 operates. In some embodiments, the simulation system 105 includes a simulation module 107 to simulate dispatching rules 151 applied to one or more operations of a process at the production environment 100. In another embodiment, the simulation system 105 communicates with an external simulation module 107 to simulate dispatching rules 151.

Simulation module 107 can execute a simulation model 163 to simulate one or more operations performed at production environment 100. Simulation model 163 is a model configured to generate predictions regarding future states of manufacturing equipment 112 and/or substrates processed at manufacturing equipment 112. In some embodiments, simulation module 107 can generate predictions by processing the predictive data generated by predictive component 119 (e.g., simulate whether the production environment can successfully process the number of substrates indicated by the predictive data). In some embodiments, simulation model 163 can generate predictions by executing one or more operations based on dispatching rules 151, state data 153, and/or user data 155. In some embodiments, simulation model 163 can generate predictions by making calculations, forecasting, statistical predictions, trend analysis, and so forth. In some embodiments, simulation model 163 can be a heuristic simulation model. In other or similar embodiments, simulation model 163 can be a machine-learning model.

In some embodiments, simulation module 107 can apply one or more simulation conditions 165 to the one or more operations simulated by simulation model 163. For example, simulation module 107 can execute simulation model 163 to simulate a particular set of operations, simulate one or more operations for a particular time period, simulate a particular number of substrates, simulate substrates having particular identifiers, and so forth. In some embodiments, simulation conditions 165 can be default conditions set by a component of production environment 100 (e.g., CIM system 101, time constraint manager 110, production dispatcher system 103) during the initialization of production environment 110. In other or similar embodiments, simulation conditions 165 can be provided to simulation module 107 during operation of production environment 100 by a component of production environment 100 or a user of production environment 100 (e.g., via client device 114).

During execution of the simulation model 163, an operation can invoke a dispatching decision. For example, an operation can trigger (e.g., call) a decision of a simulated manufacturing equipment 112 to perform a simulated operation for a simulated substrate. Simulation module 107 can identify a dispatching rule 151 (e.g., from data store 150) associated with the dispatching decision and use simulation model 163 to make the dispatching decision in accordance with the identified dispatching rule 151.

In some embodiments, one or more input parameters can be provided to the dispatching rule 151 for simulation model 163 to make the dispatching decision. The one or more input parameters can include state data 153 associated with one or more simulated manufacturing equipment 112. In other or similar embodiments, the one or more input parameters can include user data 155. Simulation module 107 can identify a parameter value (e.g., state data 153, user data 155, etc.) from data store 150 and provide the parameter value to simulation model 163 to be used for the one or more input parameters provided for dispatching rule 151.

Simulation module 107 can run simulation model 163 to represent an extended amount of time at production environment 100. For example, simulation module 107 can run simulation model 163 to simulate an hour, several hours, several days, a week, and so forth, of operation of production environment 100. During the simulation, simulation model 163 can make a significant number of dispatching decisions. Simulation module 107 can generate a report associated with the simulation and/or the dispatching decisions made by simulation model 163. In some embodiments, the report can include data corresponding to, for example, production cycle time, production throughput, equipment utilization, etc. Simulation module 107 can provide the report to one or more components of production environment 100 (e.g., time constraint manager 110, production dispatcher system 103, CIM system 101, etc.) and/or to a user of production environment 100 (e.g., via client device 114).

In some embodiments, time constraint window manager 110 can determine the number of substrates to be initiated for a set of operations for a particular time period of the manufacturing system based on a simulation of the production environment 100. Time constraint window manager 110 can determine one or more simulation conditions 175 to be applied to a simulation performed by simulation model 173. The one or more simulation conditions can include, the particular set of operations to be simulated, the particular time period to be simulated, a number of substrates to be simulated, an identification of particular substrates to be simulated, etc. In some embodiments, time constraint window manager 110 determines the one or more simulation conditions 175 based on a notification received from production dispatcher system 103 or a user of production environment 100 (e.g., via client device 114). In some embodiments, time constraint window manager 110 determines the one or more simulation conditions 175 based on the predictive data generated by model 190 and received from predictive component 119. In other or similar embodiments, time constraint window manager 110 determines the one or more simulation conditions 175 based on state data 153 associated with manufacturing equipment 112. For example, time constraint window manager 110 can determine, based on state data 153, that 100 substrates were successfully processed according to a first set of operations having time constraints within a 12 hour time period. As such, time constraint window manager 110 can determine the set of operations to be simulated are the first set of operations, the particular time period to be simulated is a 12 hour time period, and a number of substrates to be simulated is 100. Time constraint window manager can provide the simulation conditions to simulation module 107 and simulation module 107 can execute simulation models 173 based on the simulation conditions, in accordance with previously described embodiments.

Simulation module 107 can generate a report associated with the simulation for the set of operations for the particular time period of the manufacturing system. In some embodiments, the report can include data corresponding to, for example, a production throughput for a particular number of substrates simulated by simulation model 163. For example, the report can include an indication that, for 100 simulated substrates, 90 simulated substrates were successfully processed, without any time constrain violations, during each of the simulated set of operations to reach the end of the particular time period. Simulation module 107 can transmit the report to time constraint manager 110. In some embodiments, simulation module 107, or time constraint window manager 110, can transmit the report to user device 114. Client device 114 can provide data from the report to a user of the manufacturing system via a graphical user interface (GUI) displayed via the user device 114.

In response to receiving the report from simulation module 107, time constraint manager 110 can determine the number of substrates to be started at an initiating operation (i.e., of a set of operations to be performed at manufacturing equipment 112) of a time constraint window for a particular time period. As discussed previously, the determined number of substrates is referred to as a substrate limit 111. Time constraint window manager 110 can provide the substrate limit 111 to production dispatcher system 103. As described previously, production dispatcher system 103 can use the substrate limit 111 to determine whether to start processing of one or more substrates at the initiating operation during the particular time period.

FIG. 2 is a flow chart of a method 200 for training a machine-learning model, according to aspects of the present disclosure. Method 200 is performed by processing logic that can include hardware (circuitry, dedicated logic, etc.), software (such as is run on a general purpose computer system or a dedicated machine), firmware, or some combination thereof. In one implementation, method 200 can be performed by a computer system, such as computer system architecture 100 of FIG. 1. In other or similar implementations, one or more operations of method 200 can be performed by one or more other machines not depicted in the figures. In some aspects, one or more operations of method 200 can be performed by server machine 170, server machine 180, and/or predictive server 118.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, processing logic initializes a training set T to an empty set (e.g., { }).

At operation 212, processing logic obtains state data associated with operations related to the fabrication of semiconductor substrates. In some embodiments, the state data is associated with operations related to the fabrication of semiconductor substrates is historical state data. Historical state data can include data relating to a past state of manufacturing equipment 112 (e.g., past operating temperature at a particular instance of time, past operating pressure at a particular instance of time, past number of substrates being processed at the manufacturing equipment at a particular instance of time, etc.). In some embodiments, the first state data is current state data. Current state data can include data relating to the current state of manufacturing equipment 112 (e.g., current operating temperature, current operating pressure, current number of substrates being processed at the manufacturing equipment, etc.). In some embodiments, the state data is perturbed state data. Perturbed state data can include modified state data. In some embodiments, in addition to the state data, processing logic can also obtain sensor data, contextual data, task data, etc. This data can also be used in the operations discussed below.

At operation 214, processing logic determines a training set of substrates to be processed during a training set of operations. The training set of candidate substrates and the training set of operations be determined using the state data, operator input, a predetermined set of rules (e.g., one or more predetermined sets of substrates, one or more predetermined sets of operations, etc.), random input, or any combination thereof. The training set of substrates can be a simulation condition, as described with respect to FIG. 1.

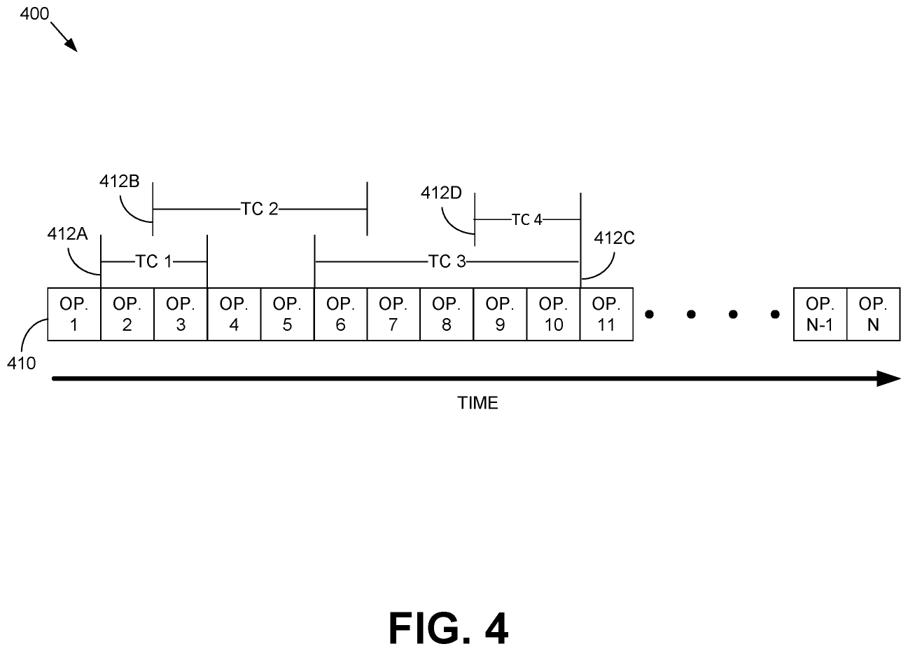

In some embodiments, the training set of operations can be the set of operations illustrated by FIG. 4. FIG. 4 illustrates a set of operations 400 subject to one or more time constraints, according to embodiments of the present disclosure. Each operation 410 of the training set of operations can correspond to an individual process performed at one or more manufacturing facilities of a production environment, such as manufacturing equipment 112 (e.g., a tool or automated device) of production environment 100. In some embodiments, each of the set of operations 400 can be consecutive operation (e.g., each operation 410 is performed in accordance with a particular ordering). In some embodiments, each operation 410 can correspond to an individual process performed at a front-end manufacturing facility, including, but not limited to, photolithography, deposition, etching, cleaning, ion implantation, chemical and mechanical polishing, etc. In other or similar embodiments, each operation can correspond to an individual process performed at a back-end manufacturing facility, including, but not limited to, dicing a completed wafer into individual semiconductor die, testing, assembly, packaging, etc.

As described previously, one or more operations 410 can be subjected to a time constraint. For example, operation 2 can be a first deposition operation to deposit a first material on a surface of a substrate and operation 3 can be a second deposition operation to deposit a second material on the first material. Operations 2 and 3 can be subject to a first time constraint where the second material is to be deposited on the first material within a particular amount of time (e.g., 6 hours) after deposition of the first material on the surface of the substrate. An amount of time for manufacturing equipment 112 to perform operations 2 and 3 can correspond to a time constraint window 412. The time constraint window 412 can include a first amount of time to complete an initiating operation (i.e., an operation 410 that initiates a time constraint window 412) and the particular amount of time in which manufacturing equipment 112 is to complete a completion operation (i.e., an operation 410 that completes the time constraint window 412). In accordance with the previous example, operation 2 is to be started for a substrate at manufacturing equipment 112 so that operations 2 and 3 will be completed for the substrate within a first time constraint window 412A.

In some embodiments, a completion operation of a time constraint window 412 can be an initiating operation for another time constraint window 412. For example, operation 3 can be a second deposition operation and operation 6 can be an etching operation. Operations 3, 4, 5, and 6 can be subject to a time constraint where the second material is to be etched at operation 6 within a particular amount of time (e.g., 12 hours) after deposition of the second material at operation 3. A second time constraint window 412B can include an amount of time to deposit the second material at operation 3 and the particular amount of time to complete operation 6. Operation 3 is to be started at manufacturing equipment 112 so that operations 3, 4, 5, and 6 will be completed within the second time constraint window 412B. In accordance with the previous example, operation 3 can be subject to a time constraint with operation 2. As such, operation 2 is to be started for a substrate so that operations 2 and 3 will be completed for the substrate within the first time constraint window 412A and that operations 3, 4, 5, and 6 will be completed within the second time constraint window 412B. The first time constraint window 412A and the second time constraint window 412B together are referred to a cascading time constraint window.

In some embodiments, an operation 410 can be subject to more than one time constraint. For example, operations 6, 7, 8, 9, and 10 can be subject to a first time constraint where operation 10 is to be completed within a particular amount of time after operation 6 is completed. A third time constraint window 412C can include an amount of time to perform operation 6 and the particular amount of time to complete operation 10. Operations 9 and 10 can also be subject to a second time constraint where operation 10 is to be completed within a particular amount of time after operation 9 is completed. A fourth time constraint window 412D can include an amount of time to complete operation 9 and the particular amount of time to complete operation 10. As such, operation 6 is to be started so that operations 6, 7, 8, 9, and 10 will be completed within the third time constraint window 412D and operations 9 and 10 will be completed within the fourth time constraint window. The third time constraint window 412C and the fourth time constraint window 412 together are referred to a nested time constraint window.

Referring back to FIG. 2, at operation 216, processing logic runs a simulation, using the state data, of the training set of operations for the training set of substrates over a time period. In some embodiments, processing logic can determine a particular time period the training set of operations are to be run at the manufacturing system. The particular time period can be a simulation condition, in accordance with previously described embodiments. In some embodiments, processing logic runs the simulation using simulation system 105.

At operation 218, processing logic receives an output of the simulation that indicates a number of candidate substrates that were successfully processed during each of the simulated set of operations to reach the end of the time period. In some embodiments, simulation module 107 can generate data associated with the simulation, in accordance with previously described embodiments. The report can indicate the number of candidate substrates, of the training set of substrates, which were successfully processed during each of the simulated training set of operations to reach the end of the time period.

At operation 220, processing logic generates training data based on the state data associated with operations related to the fabrication of semiconductor substrates, the training set of substrates, the training set of operations, and the output of the simulation. In some embodiments, the training data can include a mapping that refers to one or more of the state data, the training set of substrates, the training set of operations, and the output of the simulation, where one or more of the state data, the training set of substrates, the training set of operations, and the output of the simulation is associated with (or mapped to) one or more of the state data, the training set of substrates, the training set of operations, and the output of the simulation. At operation 222, processing logic adds the training data to the training set T.

At operation 224, processing logic determines whether the training set, T, includes a sufficient amount of training data to train a machine-learning model. It should be noted that in some implementations, the sufficiency of training set T can be determined based simply on the amount of training data or the number of mappings in the training set, while in some other implementations, the sufficiency of training set T can be determined based on one or more other criteria (e.g., a measure of diversity of the training examples, etc.) in addition to, or instead of, the number of input/output mappings. Responsive to determining the training set does not include a sufficient amount of training data to train the machine-learning model, method 200 returns to operation 212. Responsive to determining the training set T includes a sufficient amount of training data to train the machine-learning model, method 200 continues to operation 228.

At operation 226, processing logic provides the training set T to train the machine-learning model. In one implementation, the training set T is provided to training engine 182 of server machine 180 to perform the training.

In some embodiments, the processing logic can perform outlier detection methods to remove anomalies from the training set T prior to training the machine-learning model. Outlier detection methods can include techniques that identify values that differ significantly from the majority the training data. These values can be generated from errors, noise, etc.

After operation 226, the machine-learning model can be used to generate predictive data based on current state data. In some embodiments, the predictive data can include one or more dispatching decisions. For example, the machine-learning model can receive, as input, current state data and output the dispatching decision(s). As discussed above, a dispatching decision decides what action should be performed at a given time in the production environment 100. Dispatching can involve decisions such as whether to start processing a batch that has fewer substrates than allowed, or wait to start the batch until additional substrates are available so a full batch can be started. Examples of dispatching decisions can include, and are not limited to, where a substrate should be processed next in the production environment, which substrate should be picked for an idle piece of equipment in the production environment, and so forth.

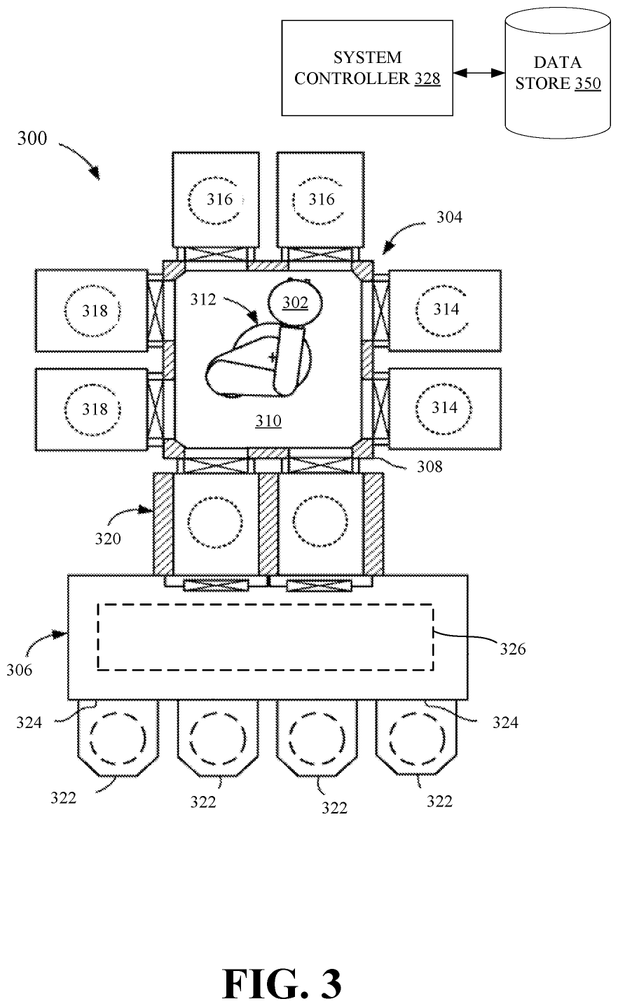

In some embodiments, a manufacturing system can include more than one process chambers. For example, example manufacturing system 300 of FIG. 3 illustrates multiple process chambers 314, 316, 318. It should be noted that, in some embodiments, data obtained to train the machine-learning model and data collected to be provided as input to the machine-learning model can be associated with the same process chamber of the manufacturing system. In other or similar embodiments, data obtained to train the machine-learning model and data collected to be provided as input to the machine-learning model can be associated with different process chambers of the manufacturing system. In other or similar embodiments, data obtained to train the machine-learning model can be associated with a process chamber of a first manufacturing system and data collected to be provide as input to the machine-learning model can be associated with a process chamber of a second manufacturing system.

FIG. 3 is a top schematic view of an example manufacturing system 300, according to aspects of the present disclosure. Manufacturing system 300 can perform one or more processes on a substrate 302. Substrate 302 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 300 can include a process tool 304 and a factory interface 306 coupled to process tool 304. Process tool 304 can include a housing 308 having a transfer chamber 310 therein. Transfer chamber 310 can include one or more process chambers (also referred to as processing chambers) 314, 316, 318 disposed therearound and coupled thereto. Process chambers 314, 316, 318 can be coupled to transfer chamber 310 through respective ports, such as slit valves or the like. Transfer chamber 310 can also include a transfer chamber robot 312 configured to transfer substrate 302 between process chambers 314, 316, 318, load lock 320, etc. Transfer chamber robot 312 can include one or multiple arms where each arm includes one or more end effectors at the end of each arm. The end effector can be configured to handle particular objects, such as wafers, sensor discs, sensor tools, etc.

Process chambers 314, 316, 318 can be adapted to carry out any number of processes on substrates 302. A same or different substrate process can take place in each processing chamber 314, 316, 318. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 314, 316, 318 can each include one or more sensors configured to capture data for substrate 302 before, after, or during a substrate process. For example, the one or more sensors can be configured to capture spectral data and/or non-spectral data for a portion of substrate 302 during a substrate process. In other or similar embodiments, the one or more sensors can be configured to capture data associated with the environment within process chamber 314, 316, 318 before, after, or during the substrate process. For example, the one or more sensors can be configured to capture data associated with a temperature, a pressure, a gas concentration, etc. of the environment within process chamber 314, 316, 318 during the substrate process.

A load lock 320 can also be coupled to housing 308 and transfer chamber 310. Load lock 320 can be configured to interface with, and be coupled to, transfer chamber 310 on one side and factory interface 306. Load lock 320 can have an environmentally-controlled atmosphere that can be changed from a vacuum environment (wherein substrates can be transferred to and from transfer chamber 310) to at or near atmospheric-pressure inert-gas environment (wherein substrates can be transferred to and from factory interface 306) in some embodiments. Factory interface 306 can be any suitable enclosure, such as, e.g., an Equipment Front End Module (EFEM). Factory interface 306 can be configured to receive substrates 302 from substrate carriers 322 (e.g., Front Opening Unified Pods (FOUPs)) docked at various load ports 324 of factory interface 306. A factory interface robot 326 (shown dotted) can be configured to transfer substrates 302 between carriers (also referred to as containers) 322 and load lock 320. Carriers 322 can be a substrate storage carrier or a replacement part storage carrier.

Manufacturing system 300 can also be connected to a client device (not shown) that is configured to provide information regarding manufacturing system 300 to a user (e.g., an operator). In some embodiments, the client device can provide information to a user of manufacturing system 300 via one or more graphical user interfaces (GUIs). For example, the client device can provide information regarding a target thickness profile for a film to be deposited on a surface of a substrate 302 during a deposition process performed at a process chamber 314, 316, 318 via a GUI. The client device can also provide information regarding a modification to a process recipe in view of a respective set of deposition settings predicted to correspond to the target profile, in accordance with embodiments described herein.

Manufacturing system 300 can also include a system controller 328. System controller 328 can be and/or include a computing device such as a personal computer, a server computer, a programmable logic controller (PLC), a microcontroller, and so on. System controller 328 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 328 can include a data storage device (e.g., one or more disk drives and/or solid state drives), a main memory, a static memory, a network interface, and/or other components. System controller 328 can execute instructions to perform any one or more of the methodologies and/or embodiments described herein. In some embodiments, system controller 328 can execute instructions to perform one or more operations at manufacturing system 300 in accordance with a process recipe. The instructions can be stored on a computer readable storage medium, which can include the main memory, static memory, secondary storage and/or processing device (during execution of the instructions).

System controller 328 can receive data from sensors included on or within various portions of manufacturing system 300 (e.g., processing chambers 314, 316, 318, transfer chamber 310, load lock 320, etc.). In some embodiments, data received by the system controller 328 can include spectral data and/or non-spectral data for a portion of substrate 302. In other or similar embodiments, data received by the system controller 328 can include data associated with processing substrate 302 at processing chamber 314, 316, 318, as described previously. For purposes of the present description, system controller 328 is described as receiving data from sensors included within process chambers 314, 316, 318. However, system controller 328 can receive data from any portion of manufacturing system 300 and can use data received from the portion in accordance with embodiments described herein. In an illustrative example, system controller 328 can receive data from one or more sensors for process chamber 314, 316, 318 before, after, or during a substrate process at the process chamber 314, 316, 318. Data received from sensors of the various portions of manufacturing system 300 can be stored in a data store 350. Data store 350 can be included as a component within system controller 328 or can be a separate component from system controller 328. In some embodiments, data store 350 can be data store 140, 150, 160 described with respect to FIG. 1.

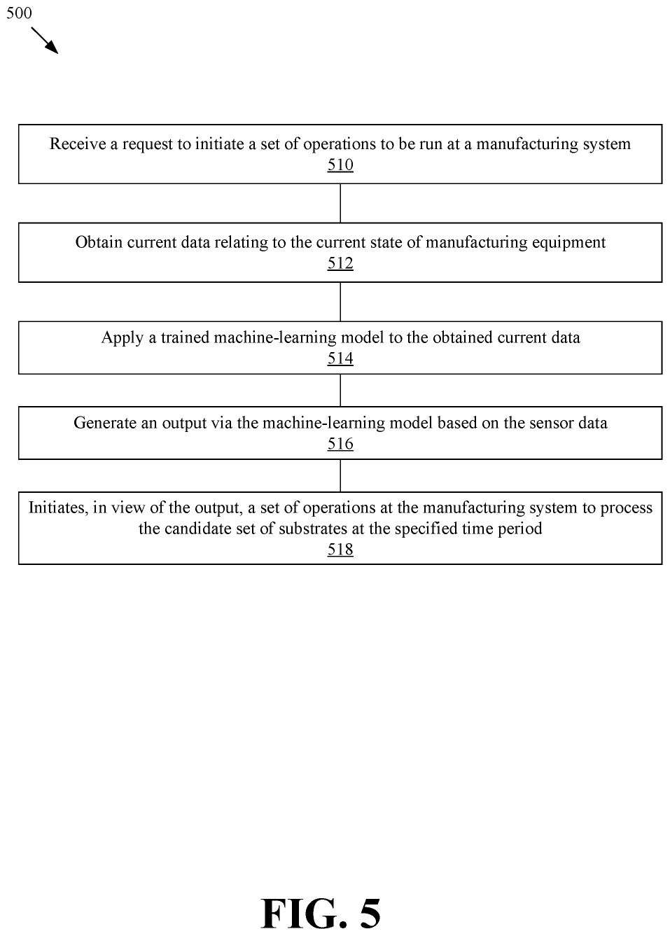

FIG. 5 is a flow chart of a method 500 for initiating a set of operations based on the dispatching decisions generated using a machine-learning model, according to aspects of the present disclosure. Method 500 is performed by processing logic that can include hardware (circuitry, dedicated logic, etc.), software (such as is run on a general purpose computer system or a dedicated machine), firmware, or some combination thereof. In one implementation, method 500 can be performed by a computer system, such as computer system architecture 100 of FIG. 1. In other or similar implementations, one or more operations of method 500 can be performed by one or more other machines not depicted in the figures. In some aspects, one or more operations of method 500 can be performed by server machine 170, server machine 180, predictive server 118, CIM system 101, production dispatcher system 103, time constraint manager 110, and/or simulation system 105.

At operation 510, the processing logic receives a request to initiate a set of operations to be run at a manufacturing system. In some embodiments, the manufacturing system can be production environment 100 of FIG. 1. In some embodiments, the request can be a request to initiate the set of operations to be run at the manufacturing system at a particular instance in time. For example, the request can be a request to initiate the set of operations at 8:00 p.m. In some embodiments, the request can be a request to initiate the set of operations on a candidate set of substrates. In some embodiments, the request can be a request for a dispatching decision(s) relating to the candidate set of substrates. For example, the request can request a next available time to initiate the set of operations on the candidate set of substrates where no time constraint issues will occur.

At operation 512, the processing logic obtains current data relating to the current state of manufacturing equipment. In some embodiments, the current data can include current state data, sensor data, contextual data, task data, etc. In some embodiments, the current data can include a number of substrates being processed at the manufacturing equipment at a particular instance of time, a number of substrates in a manufacturing equipment queue, current service life, setup data, a set of operations that include individual processes performed at one or more manufacturing facilities of a production environment, etc. In some embodiments, the current data can relate to one or more operations being performed on one or more substrates being processed. For example, the operation can include a deposition process performed in a process chamber to deposit one or more layers of film on a surface of a substrate, an etch process performed on the one or more layers of film on the surface of the substrate, etc. The operation can be performed according to a recipe. The sensor data can include a value of one or more of temperature (e.g., heater temperature), spacing, pressure, high frequency radio frequency, voltage of electrostatic chuck, electrical current, material flow, power, voltage, etc. Sensor data can be associated with or indicative of manufacturing parameters such as hardware parameters, such as settings or components (e.g., size, type, etc.) of the manufacturing equipment 112, or process parameters of the manufacturing equipment 112.

At operation 514, the processing logic applies a trained machine-learning model (e.g. model 190) to the obtained current data. The machine-learning model can be used to generate predictive data that includes one or more dispatching decisions.

At operation 516, processing logic generates an output via the machine-learning model based on the current data. In some embodiments, the output can be predictive data that includes one or more dispatching decisions. A dispatching decision decides what action should be performed at a given time in the production environment 100. In some embodiments, the dispatching decision can include a candidate set of substrates and a specified time period.

At operation 518, the processing logic initiates, in view of the output data, a set of operations at the manufacturing system to process the candidate set of substrates at the specified time period. In some embodiments, the processing device initiates the set of operations at the manufacturing system by setting a substrate limit 111 for a first operation of the set of operations to correspond to the number of candidate substrates. As described previously, time constraint window manager 110 can set the substrate limit 111 for the first operation by providing the number of candidate substrates to production dispatcher system 103. Production dispatcher system 103 can use a substrate counter value to monitor whether a number of substrates started at the initiating operation satisfies the substrate limit 111 over the time period. For example, for each substrate started at the initiating operation of the set of operations 400, production dispatcher system 103 can update the substrate counter value by decreasing the substrate counter value by one. The updated substrate counter value can indicate to the production dispatcher system 103 the number of substrates of the substrate queue that can be started that the initiating operation within the time period.

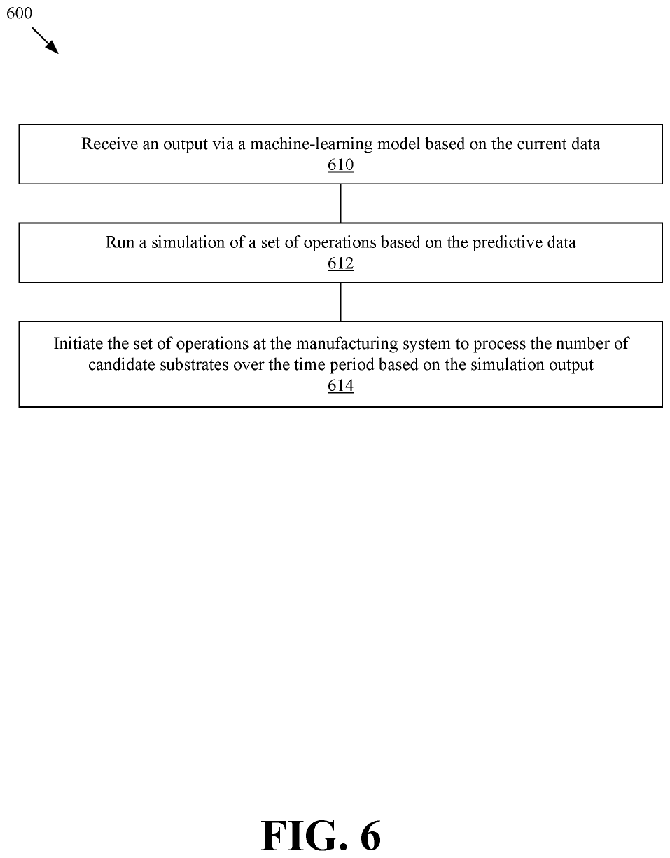

FIG. 6 is a flow chart of a method 600 for initiating a set of operations based on the dispatching decisions generated using a machine-learning model, according to aspects of the present disclosure. Method 600 is performed by processing logic that can include hardware (circuitry, dedicated logic, etc.), software (such as is run on a general purpose computer system or a dedicated machine), firmware, or some combination thereof. In one implementation, method 600 can be performed by a computer system, such as computer system architecture 100 of FIG. 1. In other or similar implementations, one or more operations of method 600 can be performed by one or more other machines not depicted in the figures. In some aspects, one or more operations of method 600 can be performed by server machine 170, server machine 180, predictive server 118, CIM system 101, production dispatcher system 103, time constraint manager 110, and/or simulation system 105.

At operation 610, the processing device can receive an output via a machine-learning model based on the current data. The output can be predictive data that includes one or more dispatching decisions. To receive the output, the processing logic can perform operations 510-516 of FIG. 5.

At operation 612, the processing logic can run a simulation of a set of operations based on the predictive data. In some embodiments, the simulation can be performed using a candidate set of substrates and a time period indicated by the dispatching decision(s). The simulation can further be based on dispatching rules for the manufacturing system, state data associated with the manufacturing system, and/or user data provided by a user of the manufacturing system (e.g., an operation, an industrial engineer, a process engineer, a system engineer, etc.). The simulation can generate an output indicating the number of candidate substrates that were successfully processed during each of the simulated set of operations to reach an end of the simulation time period. The simulation can be used to verify that the predictive data does not result in time constraint errors, or results in few time constraint errors. In some embodiments, the processing logic, or user input, can modify the predictive data (e.g., adjust the candidate set of substrates and/or the time period) based on the output of the simulation. For example, responsive to the simulation output indicating that the number of candidate substrates that were not successfully processed during the simulation time period (e.g., processed without any time constraint violations), the processing logic can adjust the start time period and/or the number of candidate substrates based on a predetermined or random value. The processing logic can then run the simulation of the set of operations based on the modified predictive data to generate a new simulation output.

At operation 614, the processing logic can initiate the set of operations at the manufacturing system to process the number of candidate substrates over the time period based on the simulation output (or the new simulation output).

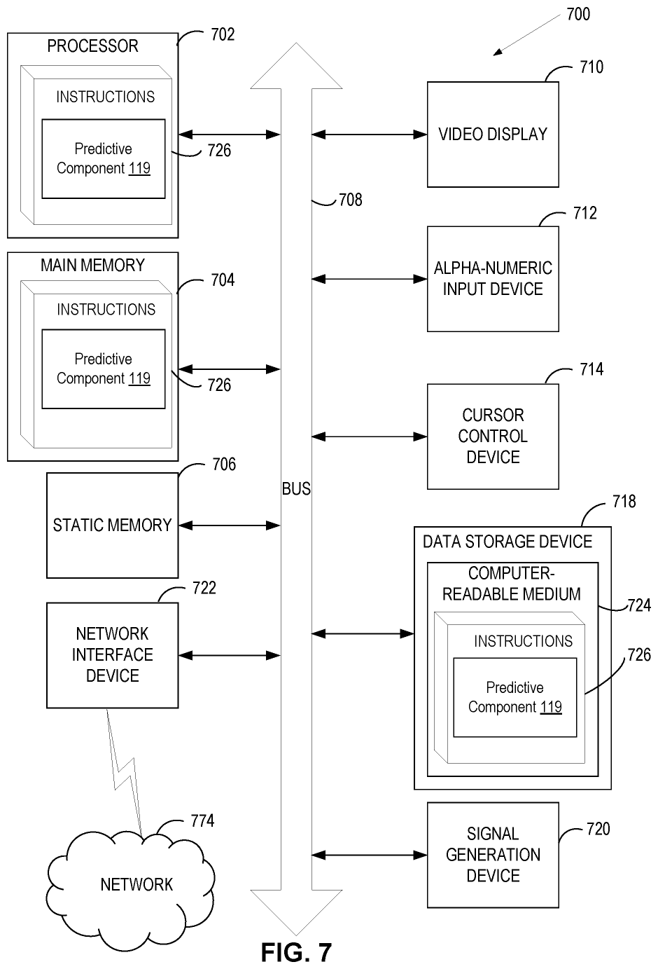

FIG. 7 is a block diagram illustrating a computer system 700, according to certain embodiments. In some embodiments, computer system 700 can be connected (e.g., via a network, such as a Local Area Network (LAN), an intranet, an extranet, or the Internet) to other computer systems. Computer system 700 can operate in the capacity of a server or a client computer in a client-server environment, or as a peer computer in a peer-to-peer or distributed network environment. Computer system 700 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 can include a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 716, which can communicate with each other via a bus 708.

Processing device 702 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 can further include a network interface device 722 (e.g., coupled to network 774). Computer system 700 also can include a video display unit 710 (e.g., an LCD), an alphanumeric input device 712 (e.g., a keyboard), a cursor control device 714 (e.g., a mouse), and a signal generation device 720.

In some implementations, data storage device 716 can include a non-transitory computer-readable storage medium 724 on which can store instructions 726 encoding any one or more of the methods or functions described herein, including instructions encoding components of FIG. 1 (e.g., predictive component 119, time constraint simulation module 107, etc.) and for implementing methods described herein.

Instructions 726 can also reside, completely or partially, within volatile memory 704 and/or within processing device 702 during execution thereof by computer system 700, hence, volatile memory 704 and processing device 702 can also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and can not have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
receiving a request to initiate a set of operations to be run at a manufacturing system, wherein the set of operations comprises one or more operations that each have one or more time constraints;
obtaining current data relating to a current state of the manufacturing system;
applying a machine-learning model to the current data to determine a candidate set of substrates to be processed during the set of operations; and
initiating the set of operations on the candidate set of substrates based on an output of the machine-learning model.

2. The method of claim 1, further comprising:
running a simulation of the set of operations for the set of candidate substrates over a time period, wherein the simulation generates a simulation output indicating a first number of candidate substrates that were successfully processed during each of the simulated set of operations to reach an end of the time period; and
initiating, in view of the simulation output, the set of operations at the manufacturing system to process the set of candidate substrates over the time period.

3. The method of claim 1, wherein the machine-learning model is trained using reinforcement learning.

4. The method of claim 1, wherein the one or more time constraints for an operation of the set of operations each comprise an amount of time after completion of the operation during which one or more subsequent operations of the plurality of operations are to be completed.

5. The method of claim 1, wherein the machine-learning model is trained based on at least one of historical state data, current state data, or perturbed state data.

6. The method of claim 5, wherein the perturbed state data comprises at least one of current state data or historical state data that has one or more parameters modified or distorted.

7. The method of claim 1, wherein output is further indicative of a time period to initiate the set of operations on the candidate set of substrates.

8. A system comprising:
a memory; and
a processing device operatively coupled with the memory, to perform operations comprising:
receiving a request to initiate a set of operations to be run at a manufacturing system, wherein the set of operations comprises one or more operations that each have one or more time constraints;
obtaining current data relating to a current state of the manufacturing system;
applying a machine-learning model to the current data to determine a candidate set of substrates to be processed during the set of operations; and
initiating the set of operations on the candidate set of substrates based on an output of the machine-learning model.

9. The system of claim 8, further comprising:
running a simulation of the set of operations for the set of candidate substrates over a time period, wherein the simulation generates a simulation output indicating a first number of candidate substrates that were successfully processed during each of the simulated set of operations to reach an end of the time period; and
initiating, in view of the simulation output, the set of operations at the manufacturing system to process the set of candidate substrates over the time period.

10. The system of claim 8, wherein the machine-learning model is trained using reinforcement learning.

11. The system of claim 8, wherein the one or more time constraints for an operation of the set of operations each comprise an amount of time after completion of the operation during which one or more subsequent operations of the plurality of operations are to be completed.

12. The system of claim 8, wherein the machine-learning model is trained based on at least one of historical state data, current state data, or perturbed state data.

13. The system of claim 12, wherein the perturbed state data comprises at least one of current state data or historical state data that has one or more parameters modified or distorted.

14. The system of claim 8, wherein output is further indicative of a time period to initiate the set of operations on the candidate set of substrates.

15. A method, comprising:
obtaining state data associated with operations related to the fabrication of substrates;
determining a training set of substrates to be processed during a training set of operations;
running a simulation, associated with the state data, of the training set of operations for the training set of substrates over a time period; and
training a machine-learning model based on an output of the simulation.

16. The method of claim 15, wherein the output of the simulation is indicative of a number of candidate substrates that were successfully processed during each of the simulated set of operations to reach the end of the time period.

17. The method of claim 15, wherein the machine-learning model is trained using reinforcement learning.

18. The method of claim 15, wherein the machine-learning model is trained based on at least one of historical state data, current state data, or perturbed state data.

19. The method of claim 15, wherein the perturbed state data comprises at least one of current state data or historical state data that has one or more parameters modified or distorted.

20. The method of claim 15, further comprising:
applying the machine-learning model to current data to determine a candidate set of substrates to be processed during the set of operations;
obtaining an output of the machine-learning model, wherein the output of the machine-learning model is indicative of the candidate set of substrates; and
initiating the set of operations on the candidate set of substrates.
